(19) United States
(12) Patent Application Publication
(10) Pub. No.: US 2021/0271698 A1
(43) Pub. Date: Sep. 2, 2021

(54) COMPUTER-READABLE RECORDING MEDIUM RECORDING ANSWERING PROGRAM, ANSWERING METHOD, AND ANSWERING DEVICE

(71) Applicant: FUJITSU LIMITED, Kawasaki-shi (JP)

(72) Inventors: Shinichi KAWAKAMI, Chiba (JP); Masaki Ohashi, Kawasaki (JP)

(73) Assignee: FUJITSU LIMITED, Kawasaki-shi (JP)

(21) Appl. No.: 17/324,659

(22) Filed: May 19, 2021

Related U.S. Application Data
(63) Continuation of application No. PCT/JP2018/047929, filed on Dec. 26, 2018.

(51) Int. Cl. G06F 16/332; G06F 16/33; G06F 16/335; G06F 16/338; G06F 16/31; H04L 12/58

(52) U.S. Cl. CPC G06F 16/3329; G06F 16/3344; H04L 51/02; G06F 16/338; G06F 16/313; G06F 16/335

(57) ABSTRACT

A non-transitory computer-readable recording medium stores therein an answering program for causing a computer to execute processing including: receiving a first inquiry from a terminal; referring to a memory that stores a category, content of an inquiry that belongs to the category, and answer candidates with respect to the inquiry in association with each other and acquiring answer candidates with respect to the received first inquiry; and outputting the answer candidates or the category to which the answer candidates belong to the terminal according to a number of the acquired answer candidates.

### CROSS-REFERENCE TO RELATED APPLICATION

This application is a continuation application of International Application PCT/JP2018/047929 filed on Dec. 26, 2018 and designated the U.S., the entire contents of which are incorporated herein by reference.

### FIELD

The embodiment discussed herein is related to an answering program, an answering method, and an answering device.

### BACKGROUND

Typically, there have been used manned systems such as call centers that receive and respond to inquiries from end users of mail order, online sales, online games, and the like and inquiries from administrators regarding system failures or the like, by telephone, e-mail, or the like. In recent years, there has been known a chat-format frequently asked questions (FAQ) system by a computer that enables responding to an inquiry from an end user, an administrator, or the like even in hours other than manned business hours.

Japanese Laid-open Patent Publication No. 2005-025418, Japanese Laid-open Patent. Publication No. 2015-069608, Japanese Laid-open Patent Publication No. 2005-202627, Japanese Laid-open Patent Publication No. 2015-011426, and Japanese Laid-open Patent Publication No. 2006-293731 are disclosed as related art.

### SUMMARY

According to an aspect of the embodiments, a non-transitory computer-readable recording medium stores therein an answering program for causing a computer to execute processing including: receiving a first inquiry from a terminal; referring to a memory that stores a category, content of an inquiry that belongs to the category, and answer candidates with respect to the inquiry in association with each other and acquiring answer candidates with respect to the received first inquiry; and outputting the answer candidates or the category to which the answer candidates belong to the terminal according to a number of the acquired answer candidates.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a view for explaining a frequently asked questions (FAQ) system according to a first embodiment;

FIG. 2 is a diagram illustrating an example of a chatbot screen;

FIG. 3 is a diagram illustrating an example of the chatbot screen;

FIG. 4 is a diagram illustrating an example of the chatbot screen;

FIG. 5 is a diagram illustrating an example of the chatbot screen;

FIG. 6 is a functional block diagram illustrating a functional configuration of an answering device according to the first embodiment;

FIG. 7 is a diagram for explaining an example of a category configuration;

FIG. 8 is a diagram illustrating an example of a data structure of a FAQ list;

FIG. 9 is a flowchart illustrating a flow of answering processing according to the first embodiment;

FIG. 10 is a diagram for explaining an example of the category configuration;

FIG. 11 is a diagram illustrating an example of the chatbot screen; and

FIG. 12 is a diagram for explaining a hardware configuration example.

### DESCRIPTION OF EMBODIMENTS

In a case where an FAQ search is performed using a chat, first, there is a method for selecting hierarchized categories in order from the top to the bottom so as to narrow a desired category, inputting a search keyword, and performing FAQ search. However, with this method, there is a case where it is not found by a user which category the FAQ to be searched belongs, Therefore, there is a case where the user selects a wrong category and cannot reach the desired FAQ. Furthermore, when the categories are hierarchized in multiple stages, there is a problem in that the user needs to select categories a plurality of times and an operation is troublesome for the user.

In one aspect, an answering program, an answering method, and an answering device that can assist an operation by a user before confirmation of answer candidates corresponding to an inquiry may be provided.

Hereinafter, an embodiment of an answering program, an answering method, and an answering device will be described in detail with reference to the drawings. Note that the present invention is not limited to this embodiment. Furthermore, each of the embodiments may be appropriately combined within a range without inconsistency.

### First Embodiment

[Overall Configuration]

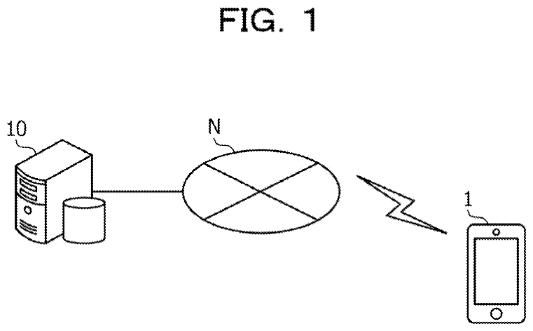

FIG. 1 is a view for explaining a frequently asked questions (FAQ) system according to a first embodiment. As illustrated in FIG. 1, the FAQ system is a system in which a user terminal 1 and an answering device 10 are connected via a network N. This FAQ system is a system in which the answering device 10 receives an inquiry from the user terminal 1 in a chat format, and responds to the user terminal 1 with an answer to the inquiry. Note that examples of the inquiry include a question from an end user of mail order, an online sale, an online game, and the like, a question from an administrator regarding a system failure or the like, and the like. Furthermore, as the network N, various communication networks such as the Internet or a dedicated line can be adopted regardless of whether the network is wired or wireless.

The user terminal 1 is an example of a computer device used by a user, and is, for example, a smartphone, a personal computer, or the like. This user terminal 1 uses a Web browser or a dedicated application to access the answering device 10, to input an inquiry and acquire an answer. In the following description, a case where the user terminal 1 is a smartphone will be described as an example.

The answering device 10 is an example of a computer device that answers to an inquiry input from the user terminal 1. When receiving an access from the user terminal 1, this answering device 10 displays a chatbot screen, which is an example of a chat-format Web screen, on the user terminal L Then, when receiving an inquiry from the user terminal 1 on the chatbot screen, the answering device 10 searches a database for an answer candidate corresponding to the inquiry, and outputs the retrieved answer candidate on the chatbot screen. In this way, the answering device 10 may provide an environment in which an answer to the inquiry can be made at any time at a user's timing regardless of business hours or the like.

In such an FAQ system, in a case where the number of acquired answer candidates is less than a predetermined number, specifically, for example, the number that fits within the chatbot screen, the answering device 10 displays an answer sentence that is an answer candidate or a title of the answer candidate on the chatbot screen. Furthermore, in a case where the number of acquired answer candidates is equal to or more than the number that fits within the chatbot screen, the answering device 10 displays categories to which the answer candidates belong, not the answer candidates.

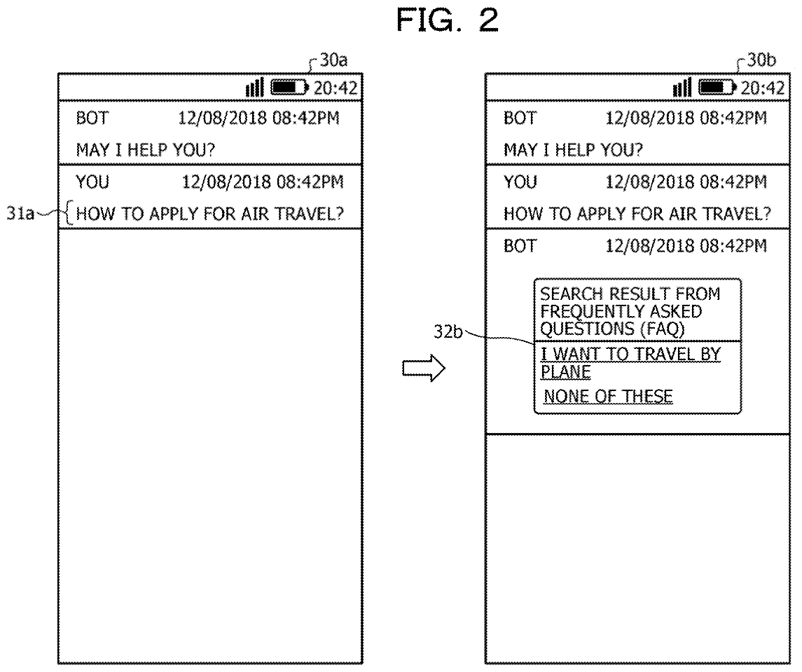

FIGS. 2 to 5 are diagrams illustrating examples of the chatbot screen. For example, as illustrated in FIG. 2, the answering device 10 displays a message “May I help you?” on a chatbot screen 30a shared with the user terminal 1. A user operates the user terminal 1 and inputs an inquiry “How to apply for an air travel?” in an inquiry field 31a of the chatbot screen 30a.

Then, the answering device 10 refers to a database and acquires answer candidates with respect to the input inquiry. In a case where the number of acquired answer candidates is less than the number that fits within the chatbot screen, the answering device 10 skips category selection and displays a title of the acquired answer candidate “I want to travel by a plane” in an answer field 32b (refer to chatbot screen 30b). Note that the answering device 10 may display an answer sentence of the answer candidate in the answer field 32b as it is.

In this way, in the first embodiment, when an inquiry is input, the answer candidates as many as the number that fits within the chatbot screen are immediately displayed. Therefore, the user can refer to an answer only by confirming the chatbot screen. Accordingly, the user does not need to perform a complicated category selection operation before referring to the answer. Furthermore, the chatbot screen displays only the answer candidates as many as the number that fits within the screen. Therefore, the user can visually and quickly recognize the answer candidates without performing an operation such as scrolling.

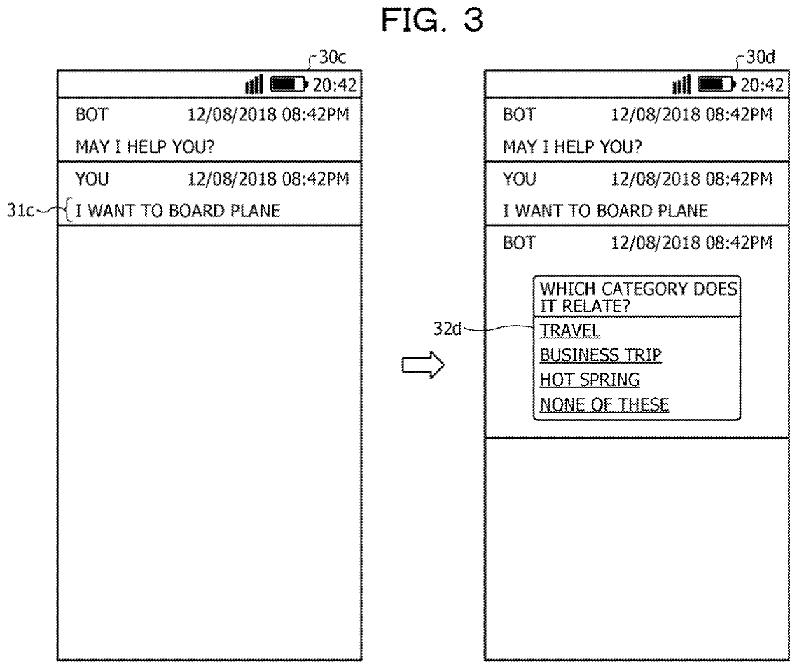

On the other hand, a case will be described where the number of answer candidates acquired in response to an inquiry “I want to board a plane” (refer to inquiry field 31c of chatbot screen 30c) in FIG. 3 is equal to or more than the number that fits within the chatbot screen.

In this case, as illustrated in FIG. 3, the answering device 10 displays categories to which the answer candidates belong, not the answer candidates, in an answer field 32d of a chatbot screen 30d. At this time, the number of categories displayed on the chatbot screen 30d is set to a certain number that fits within the chatbot screen so as to be visually recognized by the user at one time without performing the operation such as scrolling.

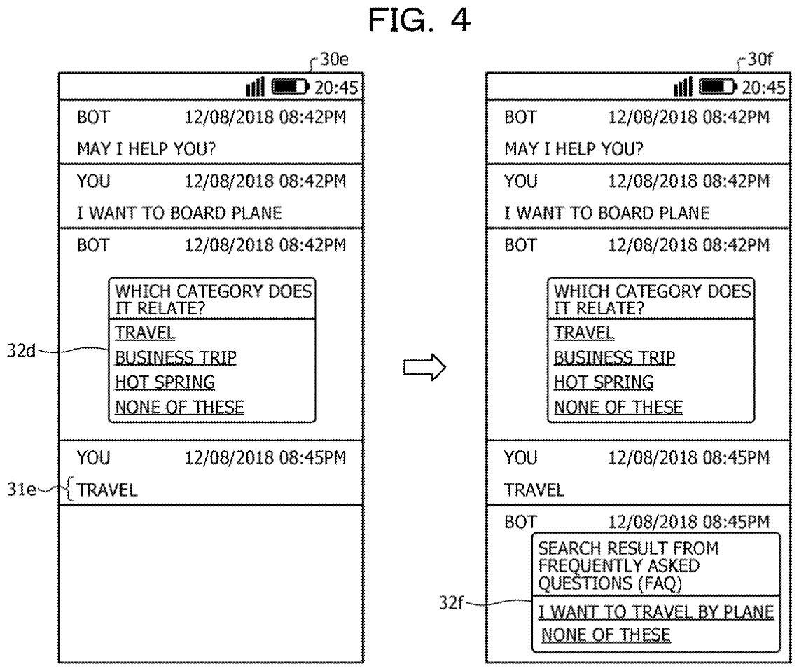

Subsequently, as illustrated in a chatbot screen 30e (refer to FIG. 4), a case will be described where the user selects “travel” from among the categories displayed in the answer field 32d (refer to input field 31e). In this case, as illustrated in a chatbot screen 30f (refer to FIG. 4), the answering device 10 displays titles of answer candidates belonging to the category “travel” in an answer field 32f. The user selects and refers to an answer candidate to be referred from among the answer candidates in the answer field 32f. In this way, because the answering device 10 automatically extracts and displays the category to which the answer candidates with respect to the inquiry belong, only one time of the category selection operation is required before the user refers to the answer. Note that the answering device 10 may display an answer sentence of the answer candidate belonging to the category “travel” in the answer field 32f.

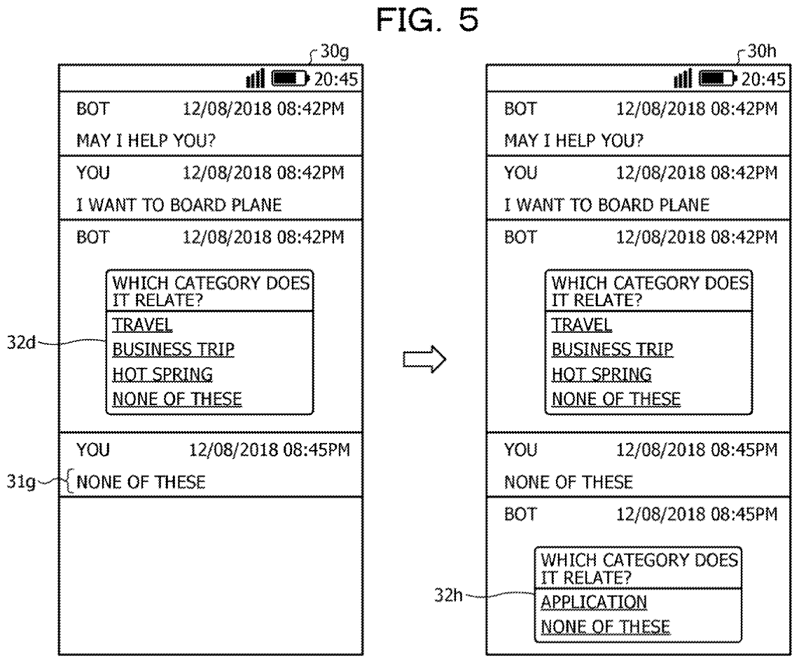

Furthermore, in the answer field 32d (refer to FIG. 3) in which the categories are displayed, the answering device 10 displays the categories and a “none of these” field indicating that no category corresponds to the inquiry. Here, as illustrated in a chatbot screen 30g (refer to FIG. 5), a case will be described where the user selects the “none of these” field (refer to input field 31g). In this case, in a case where the number of answer candidates obtained by excluding the answer candidates belonging to the category that has been already displayed from among the answer candidates acquired with respect to the inquiry is equal to or more than a predetermined number, the answering device 10 displays a non-displayed category “application” in an answer field 32h of a chatbot screen 30h. Furthermore, in a case where the number of answer candidates obtained by excluding the answer candidates belonging to the category that has been already displayed from among the answer candidates acquired with respect to the inquiry is less than the predetermined number, the answering device 10 displays the non-displayed answer candidates in the answer field 32h of the chatbot screen 30h.

Therefore, in a case where a desired category is not displayed, if the “none of these” field is selected, the user can confirm non-displayed categories or non-displayed answer candidates. Therefore, the user does not need to perform a complicated category selection operation for selecting categories in lower layers again after returning to categories in upper layers.

[Configuration of Answering Device]

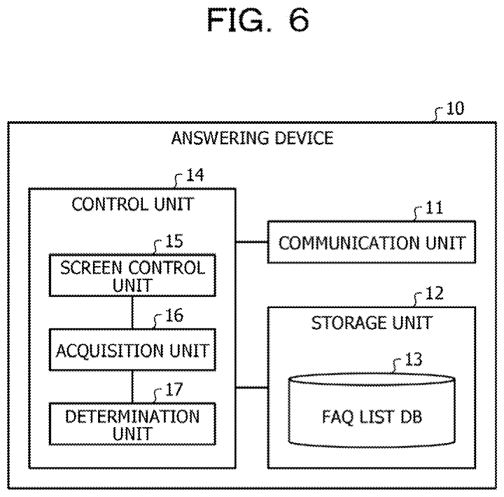

Next, a configuration of the answering device 10 illustrated in FIG. 1 will be described. FIG. 6 is a functional block diagram illustrating a functional configuration of the answering device 10 according to the first embodiment. As illustrated in FIG. 6, the answering device 10 includes a communication unit 11, a storage unit 12, and a control unit 14.

The communication unit 11 is a processing unit that controls communication with the user terminal 1 and is, for example, a communication interface or the like. For example, the communication unit 11 establishes Web communication with the user terminal 1, and transmits and receives data.

The storage unit 12 is an example of a storage device that stores programs and data and is, for example, a memory, a hard disk, and the like. The storage unit 12 stores a FAQ list database (DB) 13.

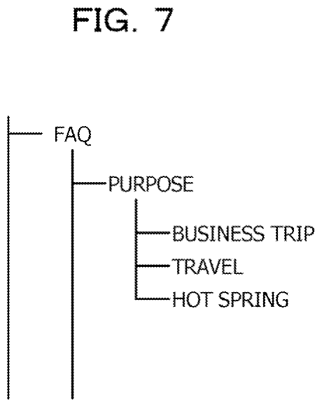

The FAQ list DB 13 is a database that stores an FAQ list in which a category, content of an inquiry, and an answer candidate with respect to the inquiry are associated with each other. First, a category configuration will be described. FIG. 7 is a diagram for explaining an example of the category configuration. As illustrated in FIG. 7, in the first embodiment, the category has, for example, a two-stage structure in which a “purpose” is associated with “business trip”, “travel”, and “hot spring”.

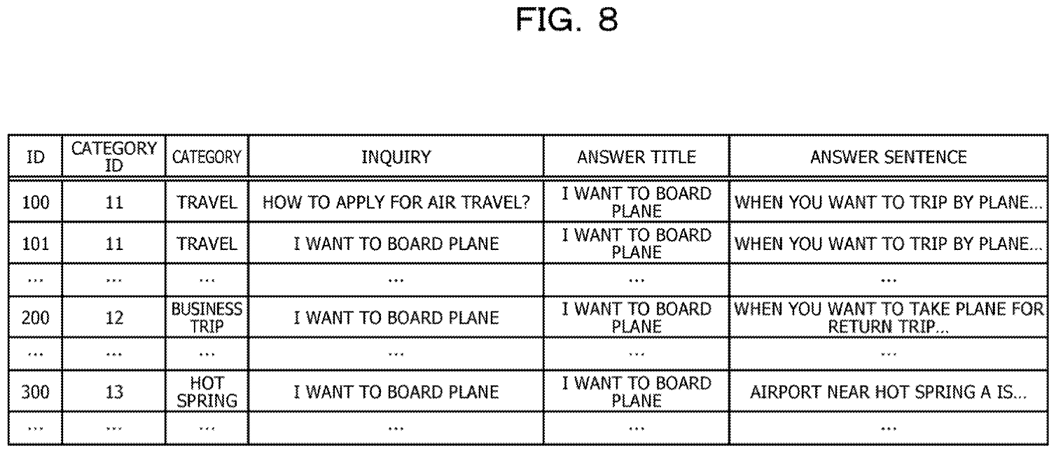

FIG. 8 is a diagram illustrating an example of a data structure of an FAQ list. As illustrated in FIG. 8, the FAQ list has items of an “ID”, a “category ID”, a “category”, an “inquiry”, an “answer title”, and an “answer sentence”. The “ID” is an identifier used to identify an FAQ. The “category ID” is an identifier used to identify a category. The “category” indicates a category to which an answer title and an answer sentence belong. The “inquiry” is content of an inquiry by a questioner. The “answer title” indicates a title of an answer with respect to the inquiry. The “answer sentence” indicates content of the answer with respect to the inquiry.

In the example in FIG. 8, an FAQ having an ID “100” corresponds to a category “travel” having a category ID of “11”. Then, the FAQ having the ID “100” is associated with an inquiry “How to apply for an air travel?”, an answer title “I want to board a plane”, and an answer sentence “when you want to trip by a plane, . . . ”. Note that a category classification method and association between the inquiry, the answer title, and the answer sentence are merely examples, and setting can be arbitrarily changed.

The control unit 14 is a processing unit that controls the entire answering device 10 and is, for example, a processor or the like. This control unit 14 includes a screen control unit 15, an acquisition unit 16, and a determination unit 17, Note that the screen control unit 15, the acquisition unit 16, and the determination unit 17 are examples of an electronic circuit such as a processor or examples of a process executed by the processor.

The screen control unit 15 is a processing unit that controls a chatbot screen with the user terminal 1. For example, when receiving access to the FAQ system from the user terminal 1, the screen control unit 15 transmits a chatbot screen to the user terminal 1. Then, the screen control unit 15 executes receiving an inquiry or the like, outputting of an answer, or the like on the chatbot screen. The screen control unit 15 is an example of an output unit.

The acquisition unit 16 refers to the FAQ list DB 13 and acquires an answer candidate with respect to the inquiry received by the screen control unit 15. The acquisition unit 16 may extract a keyword from content of the inquiry and search for an answer candidate from the FAQ list DB 13 using the keyword.

The determination unit 17 outputs the answer candidates or the categories to which the answer candidates belong to the user terminal 1 according to the number of answer candidates. According to the number of answer candidates acquired by the acquisition unit 16, the determination unit 17 determines whether to display the answer candidates on the chatbot screen of the user terminal 1 or display the categories to which the answer candidates belong on the chatbot screen of the user terminal 1. The screen control unit 15 outputs information according to the result determined by the determination unit 17. In other words, for example, the screen control unit 15 displays the answer candidates or the like on the chatbot screen of the user terminal 1 according to the result determined by the determination unit 17.

In a case where the number of answer candidates acquired by the acquisition unit 16 is less than a predetermined number, the determination unit 17 determines to display the answer candidates on the chatbot screen of the user terminal L The determination unit 17 displays answer sentences or titles of the answer candidates on the chatbot screen as the answer candidates. Here, specifically, for example, the predetermined number is the number that fits within the answer field of the chatbot screen so as to be visually recognized by the user at one time without performing the operation such as scrolling, and is set according to a size of the chatbot screen. Furthermore, the predetermined number can be changed.

On the other hand, in a case where the number of answer candidates acquired by the acquisition unit 16 is equal to or more than the predetermined number, the determination unit 17 determines to display the categories, to which the answer candidates acquired by the acquisition unit 16 belong, on the chatbot screen of the user terminal 1. The determination unit 17 displays a certain number of categories among the categories, to which the answer candidates acquired by the acquisition unit 16 belong, on the chatbot screen. Note that the number of displayed categories is set to a certain number that fits within the chatbot screen so as to be visually recognized by the user at one time without performing the operation such as scrolling. Furthermore, the determination unit 17 may sort the categories by a predetermined sorting method and display top categories on the chatbot screen. The sorting methods include, for example, a method for obtaining a harmonic mean with respect to the number of answer candidates belonging to each category and sorting the candidates in order of proximity to the obtained harmonic mean.

Then, the determination unit 17 outputs the certain number of categories and a selection field indicating that no category corresponds to the inquiry (for example, “none of these” field illustrated in FIG. 5) to the user terminal 1. In a case of receiving the selection in the selection field, the determination unit 17 outputs a non-displayed category among the categories, to which the answer candidates acquired by the acquisition unit 16 belong, to the user terminal 1. In a case of receiving the selection in the selection field, the determination unit 17 excludes the answer candidates in the categories that have been already displayed from the answer candidates acquired by the acquisition unit 16. Then, in a case where the number of the answer candidates after the exclusion is equal to or more than a predetermined number, the determination unit 17 outputs the non-displayed category to the user terminal 1. Furthermore, in a case where the number of answer candidates after the exclusion is less than the predetermined number, the determination unit 17 outputs the non-displayed answer candidate to the user terminal 1.

[Flow of Processing]

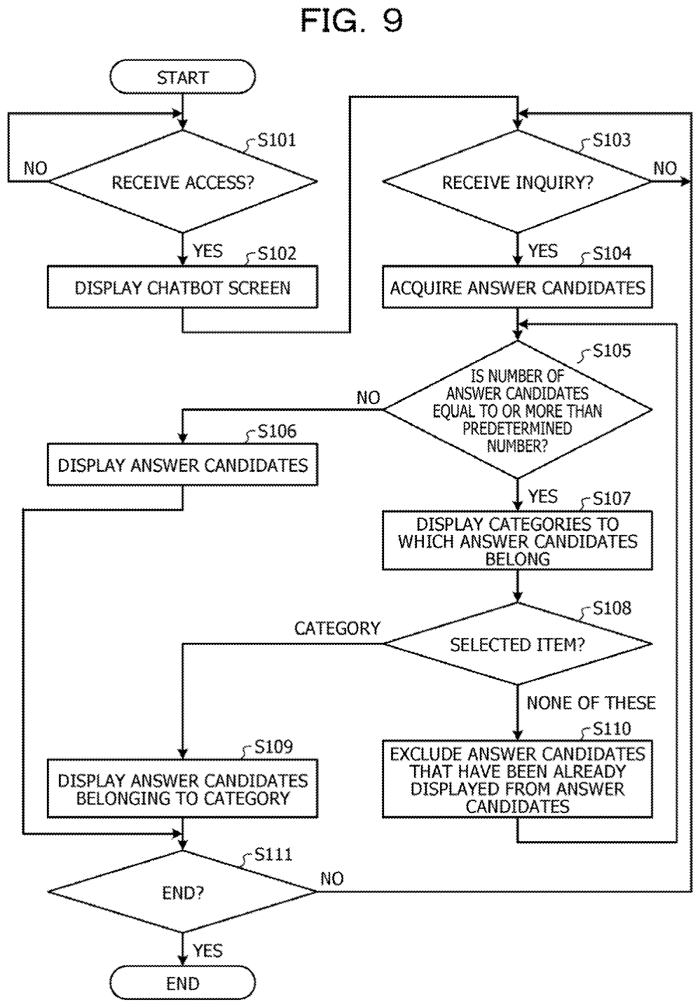

FIG. 9 is a flowchart illustrating a flow of answering processing according to the first embodiment. As illustrated in FIG. 9, when receiving an access from the user terminal 1 (step S101: Yes), the screen control unit 15 of the answering device 10 displays a chatbot screen on the user terminal 1 (step S102) In a case where the access is not received from the user terminal 1 (step S101: No), the screen control unit 15 returns to step S101.

Thereafter, in a case where the screen control unit 15 receives an inquiry from the user terminal 1 on the chatbot screen (step S103: Yes), the acquisition unit 16 refers to the FAQ list DB 13 and acquires answer candidates with respect to the received inquiry (step S104). In a case where the screen control unit 15 does not receive the inquiry from the user terminal 1 on the chatbot screen (step S103: No), the screen control unit 15 returns to step S103.

The determination unit 17 determines whether to display the answer candidates on the user terminal 1 or display the categories to which the answer candidates belong on the user terminal 1 according to the number of answer candidates acquired by the acquisition unit 16. Specifically, the determination unit 17 determines whether or not the number of answer candidates acquired by the acquisition unit 16 is equal to or more than a predetermined number (step S105).

In a case of determining that the number of acquired answer candidates is less than the predetermined number (step S105: No), the determination unit 17 displays the answer candidates on the chatbot screen of the user terminal 1 as they are (step S106).

On the other hand, in a case of determining that the number of acquired answer candidates is equal to or more than the predetermined number (step S105: Yes), the determination unit 17 displays the categories to which the acquired answer candidates belong on the chatbot screen of the user terminal 1 (step S107). At this time, on the chatbot screen, the determination unit 17 displays the certain number of categories and the “none of these” field indicating that no category corresponds to the inquiry.

Then, the determination unit 17 determines whether or not an item selected on the chatbot screen of the user terminal 1 from the user terminal 1 is a category or a “none of these” field (step S108). In a case of determining that the selected item is a category (step S108: category), the determination unit 17 displays an answer candidate belonging to the selected category from among the answer candidates acquired by the acquisition unit 16 on the chatbot screen (step S109).

On the other hand, in a case of determining that the selected item is a “none of these” field (step S108: “none of these”), the determination unit 17 excludes the answer candidates in the categories that have been already displayed from among the answer candidates acquired by the acquisition unit 16 (step S110). After the processing in step S110, the determination unit 17 proceeds to step S105 and determines whether or not the number of answer candidates after the exclusion is equal to or more than a predetermined number. In a case of determining that the number of acquired answer candidates after the exclusion is less than the predetermined number (step S105: No), the determination unit 17 displays the answer candidates on the chatbot screen of the user terminal 1 as it is (step S106). Furthermore, in a case of determining that the number of answer candidates after the exclusion is equal to or more than the predetermined number (step S105: Yes), the determination unit 17 displays the categories, to which the answer candidates after the exclusion belong, on the chatbot screen of the user terminal 1 (step S107).

Furthermore, after the processing in step S106 or after the processing in step S109, the control unit 14 determines whether or not the screen control unit 15 has accepted end of the chatbot screen (step S111).

In a case of determining that the end of the chatbot screen has been accepted (step S111: Yes), the control unit 14 terminates display of the chatbot screen. Furthermore, in a case of determining that the end of the chatbot screen has not been accepted (step S111: No), the control unit 14 proceeds to step S103.

[Effects]

In a typical FAQ system, because categories are hierarchized in multiple stages, a search keyword for an inquiry has been input by a user after performing a plurality of times of category selection operations before selecting an answer candidate.

On the other hand, when an inquiry is input, in a case where the number of acquired answer candidates is less than the predetermined number that fits within the chatbot screen, the answering device 10 according to the present first embodiment displays the answer candidates on the chatbot screen as they are. In other words, for example, in the first embodiment, when the inquiry is input, the answer candidates are displayed as they are. Therefore, the user can immediately refer to an answer only by confirming the chatbot screen. Therefore, according to the first embodiment, the user does not need to perform a complicated category selection operation that has been typically required before referring to the answer.

Furthermore, in the first embodiment, the chatbot screen displays only the answer candidates as many as the number that fits within this screen. Therefore, the user can visually and quickly recognize the answer candidates without performing the operation such as scrolling.

Furthermore, in a case where the number of acquired answer candidates is equal to or more than the number that fits within the chatbot screen, the answering device 10 displays categories to which the answer candidates belong, not the answer candidates. In this case, the user can select a desired category and refer to answer candidates. In this case, only one time of category selection operation is required before the user refers to the answer. Furthermore, because the answering device 10 sets the number of categories displayed on the chatbot screen 30d to a certain number that fits within the chatbot screen, the user can visually recognize the categories at one time without performing the operation such as scrolling.

In this way, according to the first embodiment, it is possible to simplify the operation by the user before confirming the answer candidates corresponding to the inquiry and to assist the user. Furthermore, in a case of the first embodiment, as illustrated in FIG. 7, because branches for each category hierarchy are reduced, a talk scenario is greatly simplified, and it is possible to reduce a burden of an administrator.

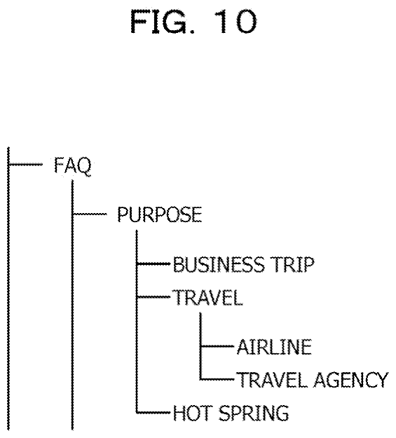

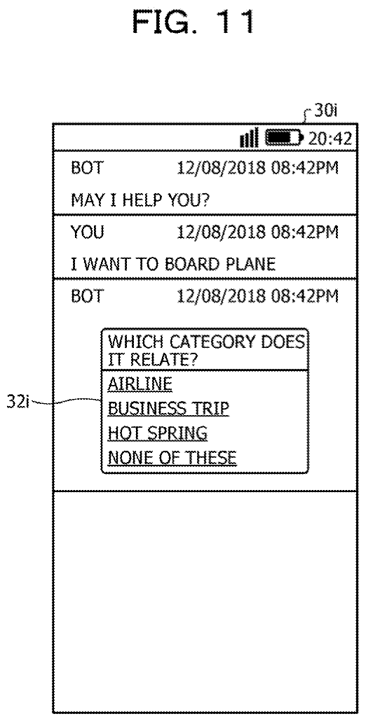

Note that, in a case where the categories are hierarchized, the determination unit 17 displays a category in the lowest layer among the categories, to which the answer candidates belong, on the chatbot screen of the user terminal 1, FIG. 10 is a diagram for explaining an example of a category configuration. FIG. 11 is a diagram illustrating an example of a chatbot screen. As illustrated in FIG. 10, a case will be described in which, in a category configuration, under “travel” under “purpose”, “airline” and “travel agency” are further provided.

For example, a case will be described where the category to which the answer candidates with respect to the inquiry “I want to board a plane” (refer to chatbot screen 30i) belong in FIG. 11 is “airline” under “business trip”, “hot spring”, and “travel”. In this case, the answering device. 10 displays “airline” under “travel” with “business trip” and “hot spring”; as categories in an answer field 32i in FIG. 11. The lower the category, the smaller the number of answer candidates included in the category. Therefore, the answering device 10 narrows the number of answer candidates displayed on the chatbot screen of the user terminal 1 by displaying the categories in the lowest layer among the categories to which the answer candidates belong so as to improve convenience of the user.

Furthermore, the present first embodiment can be applied to not only the chatbot screen but also, for example, a case where a data search result is displayed on a screen such as a manual search screen.

[System]

Pieces of information including a processing procedure, a control procedure, a specific name, various types of data, and parameters described above in the above document or illustrated in the drawings may be changed in any ways unless otherwise specified. Furthermore, the specific examples, distributions, numerical values, and the like described in the embodiments are merely examples, and may be changed in any ways.

In addition, each component of each device illustrated in the drawings is functionally conceptual and does not necessarily have to be physically configured as illustrated in the drawings. In other words, for example, specific forms of distribution and integration of each device are not limited to those illustrated in the drawings. That is, for example, all or a part of the device may be configured by being functionally or physically distributed or integrated in optional units according to various types of loads, usage situations, or the like. Moreover, all or any part of individual processing functions performed by each device may be implemented by a central processing unit (CPU) and a program analyzed and executed by the CPU, or may be implemented as hardware by wired logic.

[Hardware]

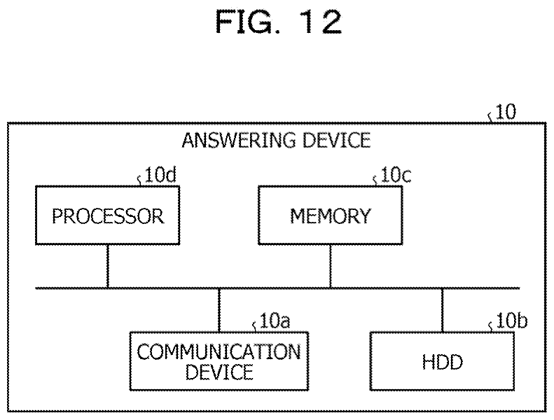

FIG. 12 is a diagram for explaining a hardware configuration example. As illustrated in FIG. 12, the answering device 10 includes a communication device 10a, a hard disk drive (HDD) 10b, a memory 10c, and a processor 10d. Furthermore, each of the units illustrated in FIG. 12 is mutually connected by a bus or the like.

The communication device 10a is a network interface card or the like and communicates with another server. The HDD 10b stores a program that activates the functions illustrated in FIG. 6, and a DB.

The processor 10d reads a program that executes processing similar to the processing of each processing unit illustrated in FIG. 6 from the HDD 10b or the like, and develops the read program in the memory 10c, thereby activating a process that performs each function described with reference to FIG. 6 or the like. In other words, for example, this process executes a function similar to the function of each processing unit included in the answering device 10. Specifically, for example, the processor 10d reads a program having functions similar to the screen control unit 15, the acquisition unit 16, the determination unit 17, or the like from the HDD 10b or the like. Then, the processor 10d executes a process for executing processing similar to those of the screen control unit 15, the acquisition unit 16, the determination unit 17, or the like.

As described above, the answering device 10 acts as an information processing device that executes an answering method by reading and executing a program. Furthermore, the answering device 10 may also implement functions similar to the functions of the above-described embodiments, by reading the program described above from a recording medium by a medium reading device and executing the read program described above. Note that this program referred to in other embodiment is not limited to being executed by the answering device 10. For example, the embodiments may be similarly applied to a case where another computer or server executes the program, or a case where such computer and server cooperatively execute the program.

This program may be distributed via a network such as the Internet. Furthermore, this program is recorded on a computer-readable recording medium such as a hard disk, flexible disk (FD), compact disc read only memory (CD-ROM), magneto-optical disk (MO), or digital versatile disc (DVD), and may be executed by being read from the recording medium by a computer.

All examples and conditional language provided herein are intended for the pedagogical purposes of aiding the reader in understanding the invention and the concepts contributed by the invertor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium having stored therein an answering program for causing a computer to execute processing comprising:
receiving a first inquiry from a terminal;
referring to a memory that stores a category, content of an inquiry that belongs to the category, and answer candidates with respect to the inquiry in association with each other and acquiring answer candidates with respect to the received first inquiry; and
outputting the answer candidates or the category to which the answer candidates belong to the terminal according to a number of the acquired answer candidates.

2. The non-transitory computer-readable recording medium having stored therein the answering program according to claim 1, wherein
the outputting processing outputs the answer candidates to the terminal in a case where the number of acquired answer candidates is less than a predetermined number, and outputs the categories, to which the acquired answer candidates belong, to the terminal, in a case where the number of acquired answer candidates is equal to or more than the predetermined number.

3. The non-transitory computer-readable recording medium having stored therein the answering program according to claim 2, wherein
in a case where the number of acquired answer candidates is equal to or more than the predetermined number, the outputting processing outputs a certain number of categories among the categories to which the acquired answer candidates belong and a selection field that indicates that no category corresponds to the inquiry to the terminal, and
the computer-readable recording medium having stored therein the answering program causes a computer to execute processing further comprising:
in a case where selection of the selection field is accepted, outputting non-displayed categories among the categories to which the acquired answer candidates belong to the terminal.

4. The non-transitory computer-readable recording medium having stored therein the answering program according to claim 3, wherein
in a case where the selection of the selection field is accepted, the outputting processing displays the non-displayed categories in a case where a number of answer candidates obtained by excluding the answer candidates in the categories that have been already displayed from the acquired answer candidates is equal to or more than a predetermined number, and displays the answer candidates not displayed in a case where the number of answer candidates obtained by excluding the answer candidates in the categories that have been already displayed from the acquired answer candidates is less than the predetermined number.

5. The non-transitory computer-readable recording medium having stored therein the answering program according to claim 1, wherein
in a case where the categories are hierarchized, the outputting processing outputs a category in a lowest layer among the categories to which the answer candidates belong to the terminal.

6. An answering method comprising:
receiving, by a computer, a first inquiry from a terminal;
referring to a memory that stores a category, content of an inquiry that belongs to the category, and answer candidates with respect to the inquiry in association with each other and acquiring answer candidates with respect to the received first inquiry; and
outputting the answer candidates or the category to which the answer candidates belong to the terminal according to a number of the acquired answer candidates.

7. The answering method according to claim 6, wherein
the outputting processing outputs the answer candidates to the terminal in a case where the number of acquired answer candidates is less than a predetermined number, and outputs the categories, to which the acquired answer candidates belong, to the terminal, in a case where the number of acquired answer candidates is equal to or more than the predetermined number.

8. The answering method according to claim 7, wherein
in a case where the number of acquired answer candidates is equal to or more than the predetermined number, the outputting processing outputs a certain number of categories among the categories to which the acquired answer candidates belong and a selection field that indicates that no category corresponds to the inquiry to the terminal, and
in a case where selection of the selection field is accepted, non-displayed categories among the categories to which the acquired answer candidates belong to the terminal are displayed.

9. The answering method according to claim 8, wherein
in a case where the selection of the selection field is accepted, the outputting processing displays the non-displayed categories in a case where a number of answer candidates obtained by excluding the answer candidates in the categories that have been already displayed from the acquired answer candidates is equal to or more than a predetermined number, and displays the answer candidates not displayed in a case where the number of answer candidates obtained by excluding the answer candidates in the categories that have been already displayed from the acquired answer candidates is less than the predetermined number.

10. The answering method according to claim 6, wherein
in a case where the categories are hierarchized, the outputting processing outputs a category in a lowest layer among the categories to which the answer candidates belong to the terminal.

11. An answering device comprising:
a memory; and
a processor coupled to the memory and configured to:
receive a first inquiry from a terminal;
refer to the memory that stores a category, content of an inquiry that belongs to the category, and answer candidates with respect to the inquiry in association with each other and acquiring answer candidates with respect to the received first inquiry; and
output the answer candidates or the category to which the answer candidates belong to the terminal according to a number of the acquired answer candidates.

12. The answering method according to claim 11, wherein
the processor outputs the answer candidates to the terminal in a case where the number of acquired answer candidates is less than a predetermined number, and outputs the categories, to which the acquired answer candidates belong, to the terminal, in a case where the number of acquired answer candidates is equal to or more than the predetermined number.

13. The answering method according to claim 12, wherein
in a case where the number of acquired answer candidates is equal to or more than the predetermined number, the processor outputs a certain number of categories among the categories to which the acquired answer candidates belong and a selection field that indicates that no category corresponds to the inquiry to the terminal, and
in a case where selection of the selection field is accepted, outputs non-displayed categories among the categories to which the acquired answer candidates belong to the terminal.

14. The answering method according to claim 13, wherein
in a case where the selection of the selection field is accepted, the processor displays the non-displayed categories in a case where a number of answer candidates obtained by excluding the answer candidates in the categories that are already displayed from the acquired answer candidates is equal to or more than a predetermined number, and displays the answer candidates not displayed in a case where the number of answer candidates obtained by excluding the answer candidates in the categories that have been already displayed from the acquired answer candidates is less than the predetermined number.

15. The answering method according to claim 11, wherein
in a case where the categories are hierarchized, the processor outputs a category in a lowest layer among the categories to which the answer candidates belong to the terminal.
